(19) United States
(12) Patent Application Publication
(10) Pub. No.: US 2023/0169836 A1
(43) Pub. Date: Jun. 1, 2023

(54) INTRUSION DETECTION SYSTEM

(71) Applicant: Alarm.com Incorporated, Tyson, VA (US)

(72) Inventors: Adam Brandfass, Pittsburgh, PA (US); Michael Kelly, Washington, DC (US)

(21) Appl. No.: 17/988,166

(22) Filed: Nov. 16, 2022

Related U.S. Application Data
(60) Provisional application No. 63/284,824, filed on Dec. 1, 2021.

(51) Int. Cl. G08B 13/196

(52) U.S. Cl. CPC G08B 13/19608; G08B 13/19656; G08B 13/19645; G08B 13/19689

(57) ABSTRACT

Methods, systems, and apparatus, including computer programs encoded on computer storage media, for detecting an intrusion at a premises. One of the methods includes determining, by an intrusion detection system and using data captured by one or more sensors that are physically located at a premises, a predicted intruder physical location of a likely intruder at the premises; determining, by the intrusion detection system, a predicted non-intruder physical location of a person at the premises who is not the likely intruder; selecting, by the intrusion detection system and using the predicted intruder physical location and the predicted non-intruder physical location, one or more shared sensors from a plurality of sensors physically located at the premises, the plurality of sensors including the one or more sensors; and providing, by the intrusion detection system and to another system, data captured by the one or more shared sensors.

### BACKGROUND

This specification relates to an intrusion detection system for a premises.

Some premises, e.g., a home or a business, can have security systems. The security systems can include one or more sensors, such as a camera or a motion sensor.

### SUMMARY

When an intrusion detection system detects an emergency situation, e.g., a break-in at a premises, the intrusion detection system can create a temporary connection with an emergency communications system. The intrusion detection system can determine a predicted length of the emergency situation and use the predicted length when creating the temporary connection so that the temporary connection will not last past the predicted length, e.g., absent an affirmative extension of the temporary connection by the intrusion detection system.

The intrusion detection system can receive, from multiple sensors at the premises, sensor data. The intrusion detection system can analyze the sensor data and provide a subset of the sensor data to the emergency communications system. This can enable the intrusion detection system to maintain privacy for the premises while providing data to the emergency communications system, which data can assist an emergency responder, such as a police officer or a firefighter, in addressing the emergency situation.

For instance, the intrusion detection system can use contextual data for the emergency situation to determine a physical location of a likely intruder, a physical location of a non-intruder, e.g., the emergency responder, a physical location of one or more people at the premises, e.g., a homeowner or a visitor, or a combination of these. The intrusion detection system can analyze the contextual data to determine which subset of the sensor data is most likely to assist the emergency responder while safely maintaining the privacy of the premises.

The intrusion detection system can provide data to one or more people at the premises. These people can include an employee, a homeowner, a visitor, or another appropriate person at the premises. The data can indicate that the person should move to a different location, a route for the person to take, data about an emergency responder who is responding to the emergency situation, or a combination of two or more of these.

In general, one innovative aspect of the subject matter described in this specification relates to providing data about an intrusion at a premises, and can be embodied in methods that include the actions of determining, by an intrusion detection system and using data captured by one or more sensors that are physically located at a premises, a predicted intruder physical location of a likely intruder at the premises; determining, by the intrusion detection system, a predicted non-intruder physical location of a person at the premises who is not the likely intruder; selecting, by the intrusion detection system and using the predicted intruder physical location and the predicted non-intruder physical location, one or more shared sensors from a plurality of sensors physically located at the premises, the plurality of sensors including the one or more sensors; and providing, by the intrusion detection system and to another system, data captured by the one or more shared sensors.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Providing the data captured by the one or more shared sensors can include providing, by the intrusion detection system and to the other system operated by the person at the premises who is not the likely intruder, the data captured by the one or more shared sensors.

In some implementations, the predicted intruder physical location can include an first area at the premises in which the likely intruder has at least a first threshold likelihood of being located. The predicted non-intruder physical location can include a second area at the premises in which the person at the premises who is not the likely intruder has at least a second threshold likelihood of being located. The first area and the second area might not overlap. The first area and the second area can overlap at least in part.

In some implementations, selecting the one or more shared sensors can include selecting the one or more sensors from the plurality of sensors. Selecting the one or more shared sensors can include selecting, from the plurality of sensors, at least one sensors other than the one or more sensors as one of the one or more shared sensors.

In some implementations, selecting the one or more shared sensors can include selecting, by the intrusion detection system, the one or more shared sensors from the plurality of sensors physically located at the premises using i) the predicted intruder physical location, ii) the predicted non-intruder physical location, and iii) one or more other predicted physical locations each for another person at the premises.

In some implementations, providing the data captured by the one or more shared sensors can include providing, to the other system and for each of the one or more shared sensors, i) the data captured by the respective sensor and ii) second data that indicates whether the captured data is for a first area within a threshold distance the predicted intruder physical location or for a second area within a second threshold distance the predicted non-intruder physical location.

In some implementations, providing the data can include providing, by the intrusion detection system and to the other system using a temporary connection that expires after a time period, the data. Determining a duration for the time period using at least one of a predicted intrusion type or the data captured by the one or more sensors that are physically located at the premises. The method can include determining that an emergency event will not likely end by an end of the time period; and in response to determining that the emergency event will not likely end by the end of the time period, extending a duration for the time period.

In some implementations, the method can include receiving, from the other system, a request to control a device physically located at the premises; determining whether permission data for the device indicates that the other system can control the device; and in response to determining whether the permission data for the device indicates that the other system can control the device, selectively providing or denying the other system's control of the device.

In some implementations, determining the predicted non-intruder physical location can include determining the predicted non-intruder physical location using data captured by a sensor from the plurality of sensors. Determining the predicted non-intruder physical location can include determining the predicted non-intruder physical location using location information received from a device operated by the person at the premises who is not the likely intruder.

In some implementations, the method can include determining, by the intrusion detection system, that a likelihood that the likely intruder is at the predicted intruder physical location no longer satisfies a threshold likelihood; and stopping, by the intrusion detection system, the provision to the other system of data captured by a sensor that was selected using the predicted intruder physical location.

The subject matter described in this specification can be implemented in various embodiments and may result in one or more of the following advantages. In some implementations, the systems and methods described in this specification can select and provide, during an emergency situation, a subset of sensor data to another system, e.g., an emergency communications system, to reduce an amount of data transmitted and a load on the network that transmits the data, to improve privacy for the premises by releasing only essential data for an emergency situation, or both, compared to other systems. In some implementations, the systems and methods described in this specification can improve security, e.g., premises security, by selectively providing sensor data, control of a device, or both, to another system, e.g., an emergency communications system, compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B depict an example of an environment with an intrusion detection system.

FIG. 2 is a flow diagram of a process for providing data about an intrusion at a premises.

FIG. 3 is a diagram illustrating an example of a home monitoring system.

Like reference numbers and designations in the various drawings indicate like elements.

### DETAILED DESCRIPTION

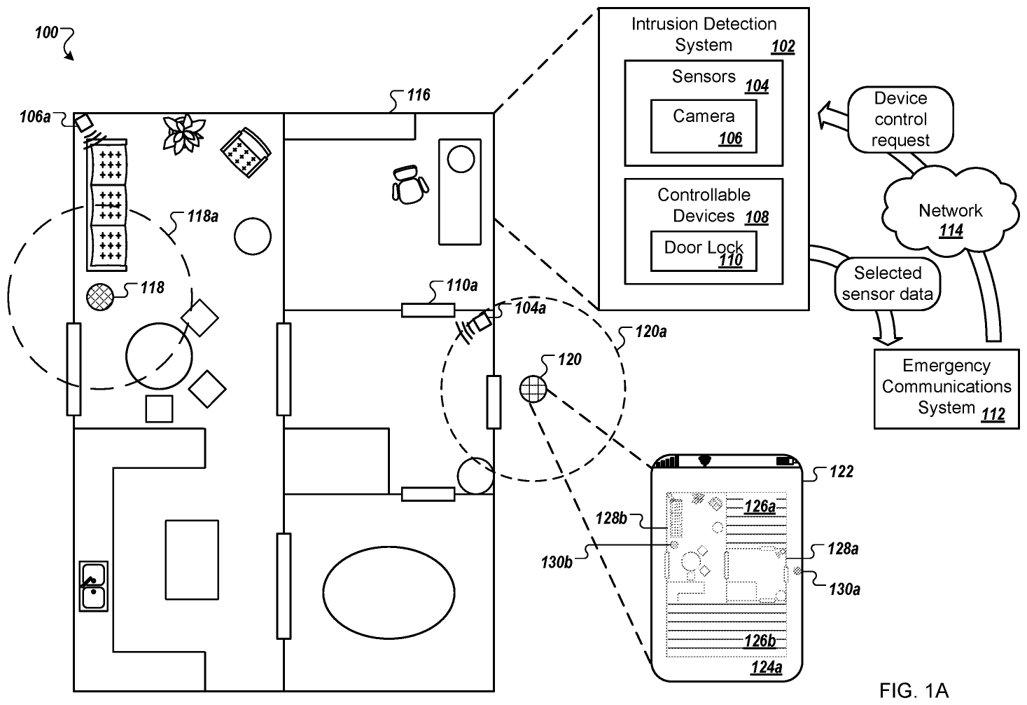

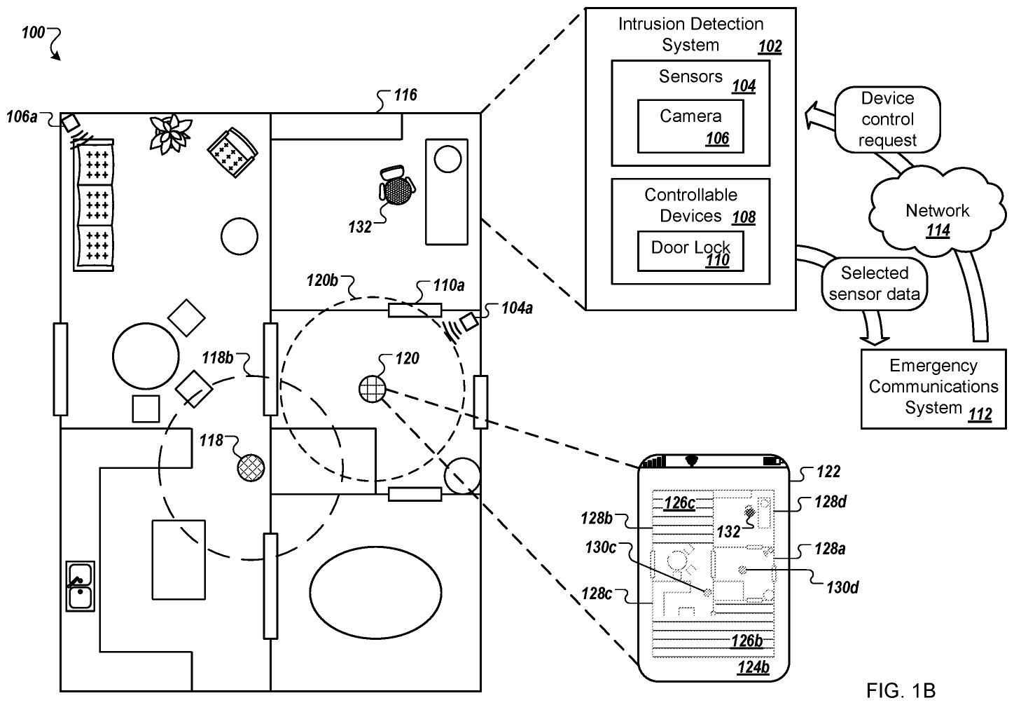

FIGS. 1A-B depict an example of an environment 100 with an intrusion detection system 102. The intrusion detection system 102 includes multiple sensors 104 from which the intrusion detection system 102 receives sensor data. The intrusion detection system 102 analyzes the sensor data to determine whether there is an emergency situation at a premises 116, e.g., a home or an office.

When the intrusion detection system 102 determines that there is an emergency situation at the premises 116, the intrusion detection system 102 selects a subset of the sensor data to send to an emergency communications system 112. The emergency communications system 112 can then receive the subset of the sensor data and coordinate an emergency response using the subset of the sensor data. This can include assigning an emergency responder to the emergency situation, providing some of the subset of the sensor data to a device operated by the emergency responder, performing another appropriate action, or some combination of these.

The intrusion detection system 102 can receive data from the one or more sensors 104. The sensors 104 can include a motion sensor 104a, a camera 106, e.g., the camera 106a, any other appropriate type of sensor for a premises 116, or a combination of these.

The intrusion detection system 102 can analyze the received sensor data to determine whether an emergency situation is likely occurring. For instance, the intrusion detection system 102 can analyze the sensor data to determine whether there is likely a break-in, a fire, a health situation, or another emergency situation at the premises 116. This can include the intrusion detection system 102 analyzing image data from the camera 106a when a security system at the premises 116 is armed to detect the opening of a door or a window at the premises 116.

When the intrusion detection system 102 determines that there is likely an emergency situation at the premises 116, the intrusion detection system 102 can determine whether to send data from some of the sensors 104 to the emergency communications system 112. For instance, the intrusion detection system 102 can determine a likely emergency situation type. Depending on the likely emergency situation type, the intrusion detection system 102 can determine whether to send a subset, e.g., a proper subset, of sensor data to the emergency communications system 112.

For instance, the intrusion detection system 102 can determine to send a subset of the sensor data to the emergency communications system 112 when the type of emergency situation is one in which one or more predetermined types of emergency responders are likely to arrive at the premises 116. The one or more predetermined types of emergency responders can include a doctor, an emergency medical technician, a police officer, a firefighter, a plumber, a heating venting and air conditioning technician, a guard, a social worker, a psychologist, a mental health professional, or another type of first responder. The predetermined types of emergency responders can include emergency responders who might or are likely to be in a situation in which information about the current activities at the premises 116, e.g., represented by the sensor data, are likely to help the emergency responder address the emergency situation.

Some examples of emergency responders for which the intrusion detection system 102 can determine to skip sending any sensor data can include a dispatcher, a social worker, a psychologist, or a mental health professional. The types of emergency responders for which the intrusion detection system can determine to skip sending any sensor data can include emergency responders who are not likely to be in a situation in which information about the current activities at the premises 116, e.g., represented by the sensor data, will necessarily help the emergency responder address the emergency situation.

The intrusion detection system 102 can use different combinations of emergency responders for which sensor data will be sent, or not sent, depending on various parameters. These parameters can include predetermined settings, emergency situation type, geographic location of the premises 116, a time of day for the emergency situation, a day of week, a number of emergency responders who can likely address the emergency situation, or a combination of two or more of these.

In some examples, the intrusion detection system 102 can determine to send a subset of sensor data when the intrusion detection system 102 determines that there is likely an intruder 118 at the premises 116. For instance, the intrusion detection system 102 can receive sensor data, e.g., image data, from the camera 106a. The intrusion detection system 102 can analyze the sensor data to determine one or more anomalies represented by the sensor data. For image data, the anomalies can be a change in context depicted in a sequence of images, such as an image depicting a likely intruder 118 who was not previously depicted in the sequence of images.

When the intrusion detection system 102 detects a likely emergency situation, the intrusion detection system 102 can determine a subset of the sensors 104 for which the intrusion detection system 102 will send data to the emergency communications system 112. The intrusion detection system 102 can determine the sensor subset using a type of the emergency situation, a physical location of the emergency situation at the premises 116, physical locations of people at the premises 116, or a combination of two or more of these.

For example, when the likely emergency situation is a fire, the intrusion detection system 102 can select all of the sensors 104 for the subset, the sensors for the areas at the premises 116 in which at least one person is likely located, or another appropriate combination of sensors. This can enable the emergency communications system 112 to direct emergency responders to one or more appropriate areas of the premises 116, e.g., in which people are likely located.

When the likely emergency situation is an intrusion, the intrusion detection system 102 can select one or more of the sensors 104 that capture data for an area 118a that includes a predicted intruder location of the likely intruder 118. In this example the predicted intruder location is represented by the likely intruder 118. Generally, the predicted intruder location can be a prediction using the accuracy of the sensors 104, movement of the likely intruder 118, the environment at the premises 116, e.g., plants or other objects that might at least partially block an area between the sensor 106a and the likely intruder 118, or a combination of these. The intrusion detection system 102 can determine that there is at least a first threshold likelihood that the likely intruder is in the area 118a.

When the intrusion detection system 102 determines to send data for the subset of the sensors 104 to the emergency communications system 112, the intrusion detection system 102 can create a connection, e.g., a temporary connection, by which the intrusion detection system 102 will send the data. The temporary connection can enable the intrusion detection system 102 to share data for a limited time period, e.g., to improve privacy for the premises 116, any people at the premises 116, or both.

The intrusion detection system 102 can select a duration for the time period using a type of the emergency situation. The duration can be fixed, e.g., the same for all emergency situation types. The duration can be dynamic, e.g., different for some emergency situation types. For instance, the intrusion detection system 102 can access a mapping of emergency situation types with predicted durations and use the selected duration for the time period. This can enable the intrusion detection system 102 to provide data to the emergency communications system 112 during the emergency situation while reducing the likelihood that data will be shared once the emergency situation is over.

Although the intrusion detection system 102 selects a duration for the time period, the intrusion detection system 102 can reduce or extend the duration. For example, as someone addresses the emergency situation, e.g., a first responder or another person at the premises 116, the intrusion detection system 102 can predict whether the duration should be longer or shorter. When the intrusion detection system 102 determines that the duration should be shorter, e.g., that the emergency situation is over, the intrusion detection system 102 can shorten the duration or terminate the temporary connection with the emergency communications system 112. When the intrusion detection system 102 determines that the duration should be longer, the intrusion detection system 102 can extend the duration, e.g., a timer for the duration that, upon expiration, terminates the temporary connection.

The intrusion detection system 102 can create the connection with the emergency communications system 112 using any appropriate process. For instance, the intrusion detection system 102 can create an identifier for the emergency situation. The intrusion detection system 102 can provide the identifier to the emergency communications system 112, e.g., with some of the selected sensor data, in a connection creation message, or both.

In some implementations, an operator of the intrusion detection system 102 can provide the identifier to, or receive the identifier from, another operator of the emergency communications system 112. For example, the intrusion detection system 102 can automatically provide the identifier to the emergency communications system 112. As part of the connection between the two systems, the systems can create a call between respective operators of the systems. During the call, the other operator of the emergency communications system 112 can provide the identifier to the operator for the intrusion detection system 102 to verify that the other operator should be provided access to the selected sensor data.

While the connection with the emergency communications system 112 is created, maintained, or both, the intrusion detection system 102 can provide the selected sensor data to the emergency communications system 112. For instance, the intrusion detection system 102 can provide data for the camera 106a to the emergency communications system 112.

The selected sensor data can include data from a subset of the sensors 104 at the premises 116, a subset of data from a single sensor 104a, 106a, or a combination of both. For instance, as the likely intruder 118 moves around the premises 116, the intrusion detection system 102 can determine the predicted physical location of the likely intruder 118. When the predicted physical location is in a living room, the intrusion detection system 102 can send data from the camera 106a that captures images of the living room to the emergency communications system 112. When the likely intruder 118 moves to a kitchen at the premises 116, the intrusion detection system 102 can stop sending data from the camera 106a and begin sending data captured by another sensor in the kitchen to the emergency communications system 112.

When the intrusion detection system 102 detects a non-intruder 120 at the premises 116, the intrusion detection system 102 can select one or more of the sensors 104, data from the sensors 104, or both, using a predicted location of both the likely intruder 118 and the non-intruder 120. The non-intruder 120 can be a first responder, e.g., a police officer or a security guard, a resident of the premises 116, an employee of a business that uses the premises 116, or someone else that the intrusion detection system 102 determines is not likely an intruder.

The intrusion detection system 102 can determine that someone is not likely an intruder using any appropriate process. For instance, the intrusion detection system 102 can receive data from the emergency communications system 112, from one of the sensors 104, from a user device 122, or another appropriate device or system, that indicates that another person is at or approaching the premises 116. The intrusion detection system 102 can analyze the data and determine that the data indicates that the other person is likely a non-intruder 120.

As the data, the intrusion detection system 102 can receive a message from the emergency communications system 112 that indicates that a first responder is going to or at the premises 116. The message can include the identifier for the emergency situation. The intrusion detection system 102 can use the identifier to determine the premises 116 to which the message corresponds.

The intrusion detection system 102 can receive data from a camera, e.g., that captures images depicting an area 120a through which the non-intruder 120 moves. The intrusion detection system 102 can analyze the data, e.g., using object recognition, to determine whether a person depicted in an image captured by the camera likely depicts an intruder or a non-intruder. For instance, the intrusion detection system 102 can include an image analysis module that determines whether the person is likely a resident, employee, or visitor of the premises 116 using facial recognition, or is wearing clothing that indicates that the person is likely a first responder. In these instances, the intrusion detection system 102 can determine that the person is likely a non-intruder.

The intrusion detection system 102 can determine that there is at least a second threshold likelihood that the non-intruder 120 is located in the area 120a. The second threshold likelihood can be the same threshold as, or a different threshold from, the first threshold likelihood.

The intrusion detection system 102 can receive data from the user device 122 that indicates that a non-intruder 120, e.g., a non-intruder, is near or at the premises 116. The user device 122 can be a device operated by a person authorized to be at the premises 116, such as a homeowner, a visitor, a security guard, or a first responder. The intrusion detection system 102 can receive the data from the user device 122 directly, e.g., through a network, or indirectly, e.g., by way of the emergency communications system 112.

The data received from the user device 122 can identify a user of the user device 122. For instance, the data can indicate that the user device 122 is operated by a first responder or a homeowner. When operated by the homeowner, the intrusion detection system 102 can receive the data from an application executing on the user device 122. The application can be a security application, e.g., associated with the intrusion detection system 102.

The intrusion detection system 102 can receive, as part of the data, location data from the user device 122. The location data can indicate a predicted location of the non-intruder 120. For example, the user device 122 can use any appropriate process to determine its predicted location and provide data that identifies the predicted location to the intrusion detection system 102.

The intrusion detection system 102 can use the predicted intruder physical location and the predicted non-intruder physical location when selecting the sensors, the sensor data, or both, to send to the emergency communications system 112. For instance, when the non-intruder 120 is a first responder, the intrusion detection system 102 can send, to the emergency communications system 112, first sensor data for a first area 118a that includes the predicted intruder physical location and second sensor data for a second area 120a that includes the predicted non-intruder physical location. This can enable the emergency communications system 112 to coordinate a response to the emergency situation, to more efficiently address the emergency situation, or both.

In some examples, the intrusion detection system 102, the emergency communications system 112, or both, can provide at least some of the selected sensor data to the user device 122. The user device 122 can receive the sensor data and use the received sensor data to present a user interface 124a. For example, the user device 122 can generate a user interface 124a that depicts a layout of the premises 116.

When the user device 122 receives only a subset, e.g., a proper subset, of data from the sensors 104, the user interface 124a can include one or more occluded areas 126a-b. These occluded areas can include areas at the premises for which the intrusion detection system 102 did not provide sensor data. As shown in FIG. 1A, the user interface includes a first occluded area 126a in the top, right corner of the user interface 124 and a second occluded area 126b at the bottom of the user interface 124.

The user interface 124 depicts information for one or more areas for which the intrusion detection system 102 selected sensor data, e.g., one or more non-occluded areas 128a-b. The depicted information can include a floor plan for the areas 128a-b. The depicted information can include information based on the sensor data, such as a first predicted location 130a of the non-intruder 120 and a second predicted location 130b of the likely intruder 118.

Presentation of the non-occluded areas 128a-b in the user interface 124a can enable a user of the user device 122, e.g., a first responder, to better address the emergency situation. For instance, the user interface 124a can depict the predicted location 130a of the likely intruder 118, which can enable the user to know whether it is likely safe to enter a foyer 128a, what actions to take when entering the foyer 128a, or both.

In some implementations, when the user interface 124a includes the one or more occluded areas 126a-b, the user interface 124a can depict information about a floorplan for the premises 116. For instance, the user interface 124a can depict an entire floorplan for the premises 116 along with information for the received subset of data from the sensors 104. In these examples, the user interface 124a can depict information that indicates the areas for which no sensor data was received, e.g., because the data for sensors in those areas was not included in the subset, there are no sensors in those areas, or a combination of both.

As the likely intruder 118, the non-intruder 120, or both, move about the premises 116, e.g., inside or within a threshold distance outside, the intrusion detection system 102 can determine different sensors for which data should be sent, different types of data, or both. For instance, when the likely intruder 118 moves from the first area 118a in the living room to a second area 118b in the kitchen, as shown in FIG. 1B, the intrusion detection system 102 can send less data for the living room, or stop sending data for the living room, to the emergency communications system 112, to the user device 122, or both. As shown in FIG. 1B, the intrusion detection system 102 can send less data for presentation on the user interface 124b, as half of the living room 128b is an occluded area 126c while the lower half is not occluded.

The intrusion detection system 102 can begin to send data for one or more sensors in the kitchen, e.g., based on the movement of the likely intruder 118 to the second area 118b in the kitchen. The user device 122 can update the user interface 124b with the updated data. This can include increasing the non-occluded area to include part or all of the kitchen 128c. This can include decreasing the size of the bottom occluded area 126b given the predicted location 130c of the likely intruder 118.

Although various portions of the user interface 124b are occluded, the occlusion does not necessarily indicate that the intrusion detection system has a sensor in the occluded area, or receives sensor data for the occluded area. Instead, the occluded areas 126a-c indicate that the intrusion detection system 102 is not providing data, e.g., sensor data or floor plan data, for these areas to improve privacy, decrease network bandwidth usage, or both.

If data for an occluded area 126a-c should be presented in the user interface 124a-b, the user device 122 can receive user input that indicates a request for presentation of data for an occluded area 126a-c. For instance, the user device 122 can receive data that indicates touch, audible, or mouse input that selects one of the occluded areas 126a-c. In response, the intrusion detection system 102 can receive a request from the user device 122 or from the emergency communications system 112 that indicates the request for data for the selected occluded area.

The intrusion detection system 102 can respond to the request by determining whether security permissions allow provision of data for the selected occluded area given contextual information for the premises 116. The contextual information can include the likely emergency situation, the predicted physical location of the likely intruder 118, the predicted physical location of the non-intruder 120, predicted locations 132 of one or more people at the premises 116, whether anyone other than the likely intruder 118 and the non-intruder 120 are at the premises 116, or a combination of these.

For instance, when the intrusion detection system 102 determines that there is not, or is not likely, another person at the premises 116 other than the likely intruder 118 and the non-intruder 120, the intrusion detection system 102 can determine to provide the requested data to the user device 122. When the intrusion detection system 102 determines that there is not likely another person in the physical area represented by the selected occlusion 126a-c in the user interface 124a-b, the intrusion detection system 102 can determine to provide the requested data to the user device 122.

When the intrusion detection system 102 determines that another person is or likely is in the physical area represented by the selected occlusion 126a-c, the intrusion detection system 102 can access one or more rules to determine whether to provide data for the selected occlusion. The rules can indicate that the intrusion detection system 102 should prompt the person in the physical area for approval to provide the data. The rules can indicate that the intrusion detection system 102 can provide the data depending on the action the person is performing, e.g., when the person is reading a book, the intrusion detection system 102 can provide data for the selected occluded area.

In some implementations, the intrusion detection system 102 can automatically provide data for an area of the premises that is not the area 118b near the likely intruder 118 or the area 120b that is near the non-intruder 120. For instance, the intrusion detection system 102 can determine that a resident of the premises 116 is likely at a location 132 in the premises 116, e.g., in an office reading a book. The intrusion detection system 102 can analyze data for the resident, the area in which the resident is physically located, one or more rules that indicate when the intrusion detection system 102 can provide data, or a combination of these, to determine whether to send data for the location 132 to the emergency communications system 112, the user device 122, or both.

When the intrusion detection system 102 provides data for the area of the premises 116 that is not near the likely intruder 118 or the non-intruder 120, the user interface 124b can present information for the area. For instance, the user interface 124b can depict the office 128d and the location 132 of the person within the office 128d.

The dynamic selection of sensors, data captured by sensors, or both, by the intrusion detection system 102 to send to the emergency communication system 112 can enable the intrusion detection system 102 to update the emergency communications system 112, the user device 122, or both, of changes to the emergency situation. In some implementations, the dynamic selection can enable the intrusion detection system 102 to minimize an amount of network bandwidth the intrusion detection system 102 uses to send data to the emergency communications system 112.

As shown in FIG. 1B, the non-intruder 120 moved from a first area 120a outside the premises 116 to a second area 120b inside the premises 116, e.g., in a foyer. As the non-intruder 120 moves through the premises, the intrusion detection system 102 detects the movement and provides updated sensor data, or data from different sensors, to the emergency communications system 112, the user device 122, or both.

In some implementations, the intrusion detection system 102 can predict the location of the non-intruder 120 using data other than data from the sensors 104 at the premises. For instance, the intrusion detection system 102 can receive location data from the user device 122, e.g., determined using GPS, Bluetooth, Wi-Fi, or cellular triangulation, and determine the predicted non-intruder location using the received location data. The intrusion detection system 102 can then select one or more of the sensors 104 and provide data from the selected sensors given the predicted non-intruder location.

The premises 116 includes one or more controllable devices 108 that can be part of the intrusion detection system 102 and over which the intrusion detection system 102 has control. These devices can include a speaker, a microphone, a thermostat, a light, a camera, and a door lock 110a, to name a few examples.

During an emergency situation, the intrusion detection system 102 can control one or more of the controllable devices 108, e.g., depending on the type of emergency situation. For instance, the intrusion detection system 102 can use the speaker to present audible content, e.g., to the likely intruder 118, that indicates that the likely intruder 118 has been detected. The intrusion detection system 102 can turn a light on or off upon detection of the likely intruder 118, e.g., to indicate the detection of the likely intruder 118.

The intrusion detection system 102 can turn a light, in a room in which a resident or employee of the premises 116 is located, on or off to signal an emergency situation. A pattern of the change in the light can indicate the type of the emergency situation.

In some examples, the intrusion detection system can receive, from the emergency communications system 112, a device control request. The device control request can identify a device from the controllable devices 108 for which the emergency communications system 112 is requesting control.

In some implementations, the emergency communications system 112, the user device 122, or both, can have a list of the sensors 104, the controllable devices 108, or both, at the premises 116. This can enable the emergency communications system 112, the user device 122, or both, to request data from a particular sensor, request control over a particular device, or both. The list can be presented in a map of the premises 116, e.g., like the user interface 124b, or another appropriate user interface.

For instance, when the user interface 124b includes data for one or more of the controllable devices 108, such as the door lock 110a, the user interface 124b can receive input that indicates changing the lock setting. This can occur when a first responder, as the non-intruder 120, determines that the door 110a should be locked given the resident in the home office and the likely intruder 118 in the kitchen.

When the intrusion detection system 102 receives a request from the emergency communications system 112, or the user device 122 for control over one of the controllable devices 108, the intrusion detection system 102 can determine whether such control should be granted. The intrusion detection system 102 can use one or more rules, contextual information for the emergency situation, or both, when determining whether to grant control. For example, the intrusion detection system 102 can determine to lock the door 110a in response to the request from the user device 122 that the door be locked, e.g., assuming that the intrusion detection system 102 did not automatically lock the door 110a in response to detecting the emergency situation.

In some implementations, the intrusion detection system 102 can determine whether control should be granted based on a location of the user device 122, the predicted non-intruder's location, or other appropriate data. For instance, when a front door to the premises 116 is locked, and the intrusion detection system 102 receives a request to unlock the front door, the intrusion detection system 102 can determine whether the non-intruder is within a threshold distance of the front door. If so, the intrusion detection system 102 can unlock the front door. If not, the intrusion detection system 102 can determine to skip unlocking the front door.

In some examples, the list of the sensors 104, the list of the controllable devices 108, or both, can include one or more filters. This can enable the emergency communications system 112, e.g., an operator of such a system, to filter by sensor or controllable device type. Once filtered, the types of sensor data sent to or used by the emergency communications system 112 can be filtered. For instance, when the emergency communications system 112 presents sensor data to an operator, the emergency communications system 112 can present only data from the selected sensor types, or present options to control the selected controllable device types, or both.

In some implementations, the user interface 124a-b presents a predicted location, either for the likely intruder 118 or the non-intruder 120, as a general area. This can occur when the premises 116 has a motion sensor that indicates that a person is likely in the area at the premises, e.g., and does not indicate a specific part of the area. When the predicted location is a general area, the user interface 124a-b can highlight an area, such as a particular room, as being the predicted location for the likely intruder 118, the non-intruder 120, or both. Different colors can be used to indicate different people or groups of people who are likely at the corresponding physical area.

In some implementations, the user interface 124a-b can be presented on a display connected to the emergency communications system 112. This can occur in addition to or instead of presenting the user interface 124a-b on the user device 122. When the user interface 124a-b is presented on a display connected to the emergency communications system 112, the emergency communications system 112, e.g., an operator of the system, can provide audible information to the non-intruder 120 about the emergency situation. The audible information can include a description of the general layout of the premises, predicted location information for the likely intruder 118, predicted location information for other people at the premises, or other appropriate information.

In some implementations, the intrusion detection system 102 can select data to send to the emergency communications system 112 using one or more permissions. The permissions can be for an operator of the emergency communications system 112, the non-intruder 120, or both. For instance, the intrusion detection system 102 can determine that the operator has access to a first set of sensor data while a first responder has access to a second, different set of sensor data. The second, different set of sensor data can be a larger set of data that provides the first responder with additional information to which the operator does not need access, e.g., given the operators role in the situation.

In some implementations, a system or device can determine how to present information on the user device 122. For instance, the intrusion detection system 102 or the emergency communications system 112 or the user device 122 can determine, using contextual information for the emergency situation, how the user device 122 should present sensor data. The contextual information can include the type of emergency; a predicted location of the likely intruder 118, e.g., compared to the predicted location of the non-intruder 120; whether another person is likely at the premises 116, such as a resident; a number of likely intruders 118; how quickly another first responder can likely arrive at the premises 116; or other appropriate contextual information.

Using the contextual information, a system or device can select a presentation type. Some example presentation types include visual, e.g., using the user interface 124a-b; audible, e.g., using a speaker in the user device 122; haptic; or a combination two or more of these. For instance, the user device 122 can present haptic information when the non-intruder 120 is in the foyer and the likely intruder 118 is in the kitchen that is adjacent to the foyer. This can enable the non-intruder 120 to prepare for an interaction with the likely intruder 118 with a lower likelihood of audibly alerting the likely intruder 118, requiring the non-intruder 120 to look at the user device 122, or both.

Some examples of non-intruders 120 include first responders, security guards, and other appropriate types of emergency response personnel.

The intrusion detection system 102 is an example of a system implemented as computer programs on one or more computers in one or more locations, in which the systems, components, and techniques described in this specification are implemented. For instance, at least part of the intrusion detection system 102 can be implemented at the premises 116, at least part of the intrusion detection system 102 can be implemented at a remote location, e.g., at a physical location for a security service, or both.

The user devices 122 can include personal computers, mobile communication devices, and other devices that can send and receive data over a network 114. The network, such as a local area network (“LAN”), wide area network (“WAN”), the Internet, or a combination thereof, connects the user devices 122, the emergency communications system 112, and the intrusion detection system 102. The intrusion detection system 102, the emergency communications system 112, or both, can use a single server computer or multiple server computers operating in conjunction with one another, including, for example, a set of remote computers deployed as a cloud computing service.

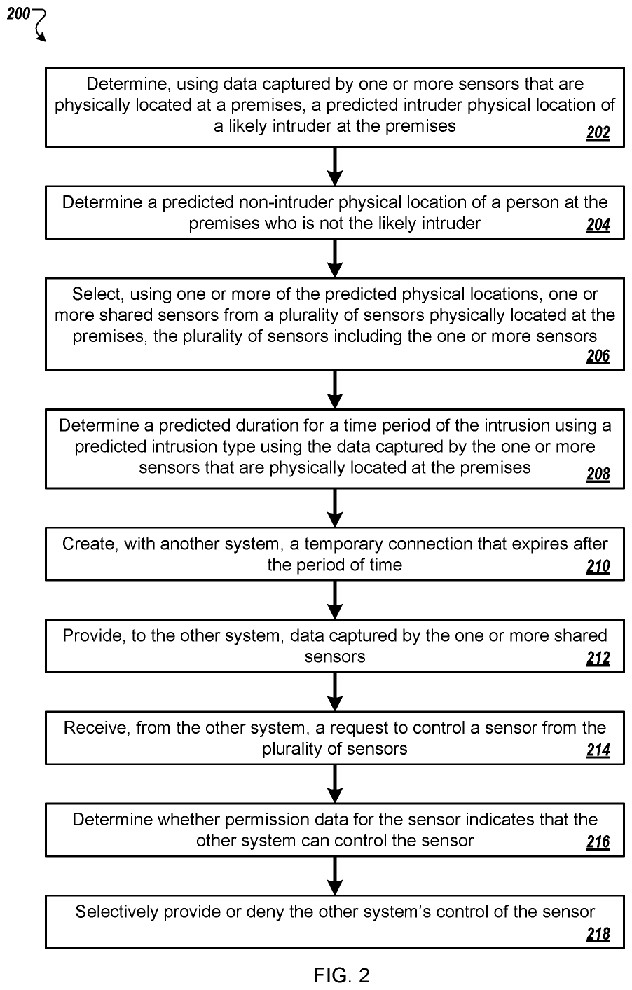

FIG. 2 is a flow diagram of a process 200 for providing data about an intrusion at a premises. For example, the process 200 can be used by the intrusion detection system 102 from the environment 100.

An intrusion detection system determines, using data captured by one or more sensors that are physically located at a premises, a predicted intruder physical location of a likely intruder at the premises (202). The sensors can be any appropriate type of sensor. For instance, the sensors can include a camera, a motion sensor, a microphone, a glass break detector, or a thermometer, to name a few examples. The likely intruder can be at the premises by being inside a building, e.g., a home or an office, or being within a threshold distance of the building, e.g., in a yard outside the home or the office.

The intrusion detection system determines a predicted non-intruder physical location of a person at the premises who is not the likely intruder (204). For example, the intrusion detection system can receive data from a user device, e.g., a smart phone. The intrusion detection system can use the received data to determine the predicted non-intruder physical location. The data can be any appropriate type of data for determining a predicted physical location, such as Wi-Fi data, Bluetooth data, GPS data, or cellular data.

The person can be a security guard, or a first responder. The person can be an employee at the premises, e.g., other than a security guard. The person can be a resident, e.g., homeowner or renter or visitor, of the premises.

The intrusion detection system selects, using one or more of the predicted physical locations, one or more shared sensors from a plurality of sensors physically located at the premises, the plurality of sensors including the one or more sensors (206). For instance, the intrusion detection system can determine one or more first sensors within a threshold distance of the predicted intruder physical location and one or more second sensors within a threshold distance of the predicted non-intruder physical location. The intrusion detection system can select the one or more first sensors and the one or more second sensors as the shared sensors.

In some examples, the intrusion detection system can select a subset of the first sensors, the second sensors, or both, as the shared sensors. For instance, the intrusion detection system can use a sensor type for each of the one or more first sensors, the one or more second sensors, or both, to determine the shared sensors. In some implementations, the intrusion detection system can use an emergency type when selecting the one or more shared sensors.

The one or more shared sensors can include any appropriate sensor located at the premises. In some examples, the shared sensors can include a sensor that is not physically located at the premises. The one or more shared sensors can include a sensor that was used to detect the likely intruder, e.g., one of the first sensors. The one or more shared sensors can include a sensor that was not used to detect the likely intruder.

The intrusion detection system determines a predicted duration for a time period of the intrusion using a predicted intrusion type using the data captured by the one or more sensors that are physically located at the premises (208). For example, the intrusion detection system can determine a likely emergency situation type using the predicted intruder location, data that indicates how the likely intruder entered the premises, or other appropriate data. The intrusion detection system can use the likely emergency situation type, a size of the premises, other appropriate data, or a combination of these, to determine the predicted duration.

The intrusion detection system creates, with another system, a temporary connection that expires after the period of time (210). For instance, the intrusion detection system can create a temporary entry in a database that includes an identifier for the emergency situation and the predicted duration. The intrusion detection system can create a connection with the other system and include the identifier in a message used to create the connection.

When the intrusion detection system determines that the time period has expired, e.g., since creation of the temporary connection, the intrusion detection system can update the database entry to indicate that no more communications for the emergency situation should be allowed. Instead of updating the database entry, the intrusion detection system can delete the database entry. In these implementations, when the intrusion detection system receives a communication from the other system that includes an identifier that is not in the database, the intrusion detection system can determine to skip responding to the communication.

The intrusion detection system provides, to the other system, data captured by the one or more shared sensors (212). For instance, the intrusion detection system can use the temporary connection to provide data captured by at least one of the one or more shared sensors to the other system.

Before sending data, the intrusion detection system can determine whether the time period for the emergency situation has expired. For instance, the intrusion detection system can determine whether the time period has expired. If so, the intrusion detection system can determine to skip sending any additional sensor data. If not, the intrusion detection system can determine to send the sensor data.

The intrusion detection system can provide data that indicates whether the shared sensor data is data for a sensor within a threshold distance of one of the predicted physical locations. There can be a first threshold distance for the predicted intruder physical location. There can be a second threshold distance for the predicted non-intruder physical location. The first and second threshold distances can be the same threshold or different thresholds.

The intrusion detection system receive, from the other system, a request to control a sensor from the plurality of sensors (214). Upon receipt, the intrusion detection system can determine whether the time period has expired, whether the other system has permission to control the sensor, or both.

The intrusion detection system determines whether permission data for the sensor indicates that the other system can control the sensor (216). For instance, in response to receipt of the request, the intrusion detection system can access the permission data. The permission data can be any appropriate type of permission data, such as security permissions, or rules.

The intrusion detection system selectively provides or denies the other system's control of the sensor (218). For instance, if the time period has expired, or the other system does not have permission to control the sensor, the intrusion detection system can deny the request. This can include sending a message to the other system that indicates that the request was denied. If the time period has not expired and the other system has permission to control the sensor, the intrusion detection system can allow the request.

The order of steps in the process 200 described above is illustrative only, and providing data about the intrusion at the premises can be performed in different orders. For example, the intrusion detection system can determine the predicted non-intruder physical location and then determine the predicted intruder physical location. This can occur when the person is a security guard who is already located at the premises. In some examples, the intrusion detection system can determine the predicted duration and then select the one or more shared sensors, determine the predicted non-intruder physical location, or both.

In some implementations, the process 200 can include additional steps, fewer steps, or some of the steps can be divided into multiple steps. For example, the intrusion detection system can perform steps 202, 206, 210, and 212 without performing the other steps in the process 200. The intrusion detection system can perform steps 202, 204, 206, 210, and 212 without performing the other steps in the process 200. In some examples, the intrusion detection system can perform steps 202, 204, 214, 216, and 218 without performing the other steps in the process 200.

In some implementations, the intrusion detection system can use the predicted intruder physical location to determine a predicted path of the likely intruder. The intrusion detection system can use the predicted path to determine the one or more shared sensors, to control one or more controllable devices at the premises, or both. For instance, the intrusion detection system can provide to the other system, e.g., the emergency communications system or the user device, sensor data for a sensor within a threshold distance from the predicted path for which the intrusion detection system would not otherwise provide sensor data, e.g., based on the predicted physical locations.

The intrusion detection system can automatically control one or more of the controllable devices, e.g., without receiving a request from the other system. For example, the intrusion detection system can determine the predicted path for the likely intruder and that there is a controllable door lock on the predicted path. In response, the intrusion detection system can determine whether the door is locked. If the door is locked, the intrusion detection system can determine to skip taking further action. If the door is unlocked, the intrusion detection system can send a signal to the door to cause the door to lock.

In some examples, the intrusion detection system can automatically lock a door, or perform another automated action, based on a location of a person, e.g., a resident, at the premises. The automated action can include locking a door, turning a light on or off, presenting an audible message, or a combination of two or more of these.

In some implementations, the intrusion detection system can receive a command that overrides a prior decision made by the intrusion detection system. The intrusion detection system can receive the command from a user device, e.g., operated by a homeowner or manager for the premises. The command can override any appropriate decision made by the intrusion detection system, such as selecting or not selecting a particular shared sensor, providing or denying access to a controllable device, or both.

For situations in which the systems discussed here collect personal information about people, or may make use of personal information, the people may be provided with an opportunity to control whether programs or features collect personal information (e.g., information about a person's physical location, activities, profession, or preferences), or to control whether and/or how access to sensor data, controllable devices, or both, is granted. In addition, certain data may be anonymized in one or more ways before it is stored or used, so that personally identifiable information is removed. Thus, a person may have control over how information is collected about him or her and used by an intrusion detection system, an emergency communications system, or both.

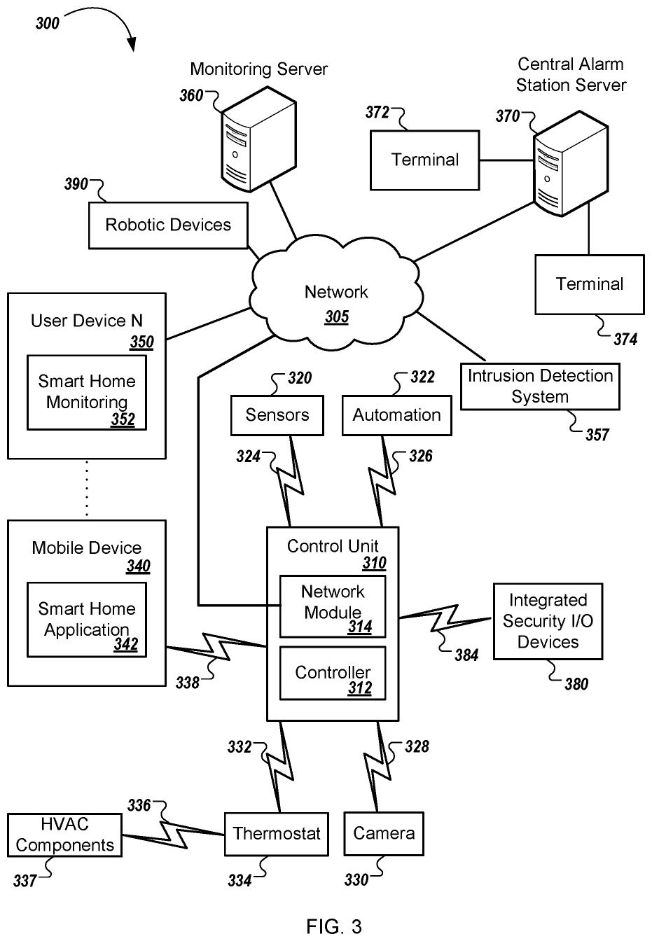

FIG. 3 is a diagram illustrating an example of a home monitoring system 300. The home monitoring system 300 includes a network 305, a control unit 310, one or more user devices 340 and 350, a monitoring server 360, and a central alarm station server 370. In some examples, the network 305 facilitates communications between the control unit 310, the one or more user devices 340 and 350, the monitoring server 360, and the central alarm station server 370.

The network 305 is configured to enable exchange of electronic communications between devices connected to the network 305. For example, the network 305 may be configured to enable exchange of electronic communications between the control unit 310, the one or more user devices 340 and 350, the monitoring server 360, and the central alarm station server 370. The network 305 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 305 may include multiple networks or subnetworks, each of which may include, for example, a wired or wireless data pathway. The network 305 may include a circuit-switched network, a packet-switched data network, or any other network able to carry electronic communications (e.g., data or voice communications). For example, the network 305 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 305 may include one or more networks that include wireless data channels and wireless voice channels. The network 305 may be a wireless network, a broadband network, or a combination of networks including a wireless network and a broadband network.

The control unit 310 includes a controller 312 and a network module 314. The controller 312 is configured to control a control unit monitoring system (e.g., a control unit system) that includes the control unit 310. In some examples, the controller 312 may include a processor or other control circuitry configured to execute instructions of a program that controls operation of a control unit system. In these examples, the controller 312 may be configured to receive input from sensors, flow meters, or other devices included in the control unit system and control operations of devices included in the household (e.g., speakers, lights, doors, etc.). For example, the controller 312 may be configured to control operation of the network module 314 included in the control unit 310.

The network module 314 is a communication device configured to exchange communications over the network 305. The network module 314 may be a wireless communication module configured to exchange wireless communications over the network 305. For example, the network module 314 may be a wireless communication device configured to exchange communications over a wireless data channel and a wireless voice channel. In this example, the network module 314 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 314 also may be a wired communication module configured to exchange communications over the network 305 using a wired connection. For instance, the network module 314 may be a modem, a network interface card, or another type of network interface device. The network module 314 may be an Ethernet network card configured to enable the control unit 310 to communicate over a local area network and/or the Internet. The network module 314 also may be a voice band modem configured to enable the alarm panel to communicate over the telephone lines of Plain Old Telephone Systems (POTS).

The control unit system that includes the control unit 310 includes one or more sensors. For example, the monitoring system 300 may include multiple sensors 320. The sensors 320 may include a lock sensor, a contact sensor, a motion sensor, or any other type of sensor included in a control unit system. The sensors 320 also may include an environmental sensor, such as a temperature sensor, a water sensor, a rain sensor, a wind sensor, a light sensor, a smoke detector, a carbon monoxide detector, an air quality sensor, etc. The sensors 320 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart-rate, respiration rate, sugar or glucose level, bodily temperature, or motion data. The sensors 320 can also include a radio-frequency identification (RFID) sensor that identifies a particular article that includes a pre-assigned RFID tag.

The control unit 310 communicates with the home automation controls 322 and a camera 330 to perform monitoring. The home automation controls 322 are connected to one or more devices that enable automation of actions in the home. For instance, the home automation controls 322 may be connected to one or more lighting systems and may be configured to control operation of the one or more lighting systems. Also, the home automation controls 322 may be connected to one or more electronic locks at the home and may be configured to control operation of the one or more electronic locks (e.g., control Z-Wave locks using wireless communications in the Z-Wave protocol). Further, the home automation controls 322 may be connected to one or more appliances at the home and may be configured to control operation of the one or more appliances. The home automation controls 322 may include multiple modules that are each specific to the type of device being controlled in an automated manner. The home automation controls 322 may control the one or more devices based on commands received from the control unit 310. For instance, the home automation controls 322 may cause a lighting system to illuminate an area to provide a better image of the area when captured by a camera 330.

The camera 330 may be a video/photographic camera or other type of optical sensing device configured to capture images. For instance, the camera 330 may be configured to capture images of an area within a building or home monitored by the control unit 310. The camera 330 may be configured to capture single, static images of the area or video images of the area in which multiple images of the area are captured at a relatively high frequency (e.g., thirty images per second) or both. The camera 330 may be controlled based on commands received from the control unit 310.

The camera 330 may be triggered by several different types of techniques. For instance, a Passive Infra-Red (PIR) motion sensor may be built into the camera 330 and used to trigger the camera 330 to capture one or more images when motion is detected. The camera 330 also may include a microwave motion sensor built into the camera and used to trigger the camera 330 to capture one or more images when motion is detected. The camera 330 may have a “normally open” or “normally closed” digital input that can trigger capture of one or more images when external sensors (e.g., the sensors 320, PIR, door/window, etc.) detect motion or other events. In some implementations, the camera 330 receives a command to capture an image when external devices detect motion or another potential alarm event. The camera 330 may receive the command from the controller 312 or directly from one of the sensors 320.

In some examples, the camera 330 triggers integrated or external illuminators (e.g., Infra-Red, Z-wave controlled “white” lights, lights controlled by the home automation controls 322, etc.) to improve image quality when the scene is dark. An integrated or separate light sensor may be used to determine if illumination is desired and may result in increased image quality.

The camera 330 may be programmed with any combination of time/day schedules, system “arming state”, or other variables to determine whether images should be captured or not when triggers occur. The camera 330 may enter a low-power mode when not capturing images. In this case, the camera 330 may wake periodically to check for inbound messages from the controller 312. The camera 330 may be powered by internal, replaceable batteries, e.g., if located remotely from the control unit 310. The camera 330 may employ a small solar cell to recharge the battery when light is available. The camera 330 may be powered by the controller's 312 power supply if the camera 330 is co-located with the controller 312.

In some implementations, the camera 330 communicates directly with the monitoring server 360 over the Internet. In these implementations, image data captured by the camera 330 does not pass through the control unit 310 and the camera 330 receives commands related to operation from the monitoring server 360.

The system 300 also includes thermostat 334 to perform dynamic environmental control at the home. The thermostat 334 is configured to monitor temperature and/or energy consumption of an HVAC system associated with the thermostat 334, and is further configured to provide control of environmental (e.g., temperature) settings. In some implementations, the thermostat 334 can additionally or alternatively receive data relating to activity at a home and/or environmental data at a home, e.g., at various locations indoors and outdoors at the home. The thermostat 334 can directly measure energy consumption of the HVAC system associated with the thermostat, or can estimate energy consumption of the HVAC system associated with the thermostat 334, for example, based on detected usage of one or more components of the HVAC system associated with the thermostat 334. The thermostat 334 can communicate temperature and/or energy monitoring information to or from the control unit 310 and can control the environmental (e.g., temperature) settings based on commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In addition, the control unit 310 can be a gateway device that communicates with the dynamically programmable thermostat 334. In some implementations, the thermostat 334 is controlled via one or more home automation controls 322.

A module 337 is connected to one or more components of an HVAC system associated with a home, and is configured to control operation of the one or more components of the HVAC system. In some implementations, the module 337 is also configured to monitor energy consumption of the HVAC system components, for example, by directly measuring the energy consumption of the HVAC system components or by estimating the energy usage of the one or more HVAC system components based on detecting usage of components of the HVAC system. The module 337 can communicate energy monitoring information and the state of the HVAC system components to the thermostat 334 and can control the one or more components of the HVAC system based on commands received from the thermostat 334.

The system 300 includes intrusion detection system 357. The intrusion detection system 357 can be computing devices (e.g., a computer, microcontroller, FPGA, ASIC, or other device capable of electronic computation) capable of receiving data related to the intrusion detection system and communicating electronically with the monitoring system control unit 310.

In some examples, the system 300 further includes one or more robotic devices 390. The robotic devices 390 may be any type of robots that are capable of moving and taking actions that assist in home monitoring. For example, the robotic devices 390 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and also roll along the ground, walls, or ceiling) and land vehicle type devices (e.g., automated cars that drive around a home). In some cases, the robotic devices 390 may be robotic devices 390 that are intended for other purposes and merely associated with the system 300 for use in appropriate circumstances. For instance, a robotic vacuum cleaner device may be associated with the monitoring system 300 as one of the robotic devices 390 and may be controlled to take action responsive to monitoring system events.

In some examples, the robotic devices 390 automatically navigate within a home. In these examples, the robotic devices 390 include sensors and control processors that guide movement of the robotic devices 390 within the home. For instance, the robotic devices 390 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 390 may include control processors that process output from the various sensors and control the robotic devices 390 to move along a path that reaches the desired destination and avoids obstacles. In this regard, the control processors detect walls or other obstacles in the home and guide movement of the robotic devices 390 in a manner that avoids the walls and other obstacles.

In addition, the robotic devices 390 may store data that describes attributes of the home. For instance, the robotic devices 390 may store a floorplan and/or a three-dimensional model of the home that enables the robotic devices 390 to navigate the home. During initial configuration, the robotic devices 390 may receive the data describing attributes of the home, determine a frame of reference to the data (e.g., a home or reference location in the home), and navigate the home based on the frame of reference and the data describing attributes of the home. Further, initial configuration of the robotic devices 390 also may include learning of one or more navigation patterns in which a user provides input to control the robotic devices 390 to perform a specific navigation action (e.g., fly to an upstairs bedroom and spin around while capturing video and then return to a home charging base). In this regard, the robotic devices 390 may learn and store the navigation patterns such that the robotic devices 390 may automatically repeat the specific navigation actions upon a later request.

In some examples, the robotic devices 390 may include data capture and recording devices. In these examples, the robotic devices 390 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 390 to take and store a biometric sample that can be used to identify the person (e.g., a biometric sample with DNA that can be used for DNA testing).

In some implementations, the robotic devices 390 may include output devices. In these implementations, the robotic devices 390 may include one or more displays, one or more speakers, and/or any type of output devices that allow the robotic devices 390 to communicate information to a nearby user.

The robotic devices 390 also may include a communication module that enables the robotic devices 390 to communicate with the control unit 310, each other, and/or other devices. The communication module may be a wireless communication module that allows the robotic devices 390 to communicate wirelessly. For instance, the communication module may be a Wi-Fi module that enables the robotic devices 390 to communicate over a local wireless network at the home. The communication module further may be a 900 MHz wireless communication module that enables the robotic devices 390 to communicate directly with the control unit 310. Other types of short-range wireless communication protocols, such as Bluetooth, Bluetooth LE, Z-wave, ZigBee, etc., may be used to allow the robotic devices 390 to communicate with other devices in the home. In some implementations, the robotic devices 390 may communicate with each other or with other devices of the system 300 through the network 305.

The robotic devices 390 further may include processor and storage capabilities. The robotic devices 390 may include any suitable processing devices that enable the robotic devices 390 to operate applications and perform the actions described throughout this disclosure. In addition, the robotic devices 390 may include solid-state electronic storage that enables the robotic devices 390 to store applications, configuration data, collected sensor data, and/or any other type of information available to the robotic devices 390.

The robotic devices 390 are associated with one or more charging stations. The charging stations may be located at predefined home base or reference locations in the home. The robotic devices 390 may be configured to navigate to the charging stations after completion of tasks needed to be performed for the home monitoring system 300. For instance, after completion of a monitoring operation or upon instruction by the control unit 310, the robotic devices 390 may be configured to automatically fly to and land on one of the charging stations. In this regard, the robotic devices 390 may automatically maintain a fully charged battery in a state in which the robotic devices 390 are ready for use by the home monitoring system 300.

The charging stations may be contact based charging stations and/or wireless charging stations. For contact based charging stations, the robotic devices 390 may have readily accessible points of contact that the robotic devices 390 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 390 may charge through a wireless exchange of power. In these cases, the robotic devices 390 need only locate themselves closely enough to the wireless charging stations for the wireless exchange of power to occur. In this regard, the positioning needed to land at a predefined home base or reference location in the home may be less precise than with a contact based charging station. Based on the robotic devices 390 landing at a wireless charging station, the wireless charging station outputs a wireless signal that the robotic devices 390 receive and convert to a power signal that charges a battery maintained on the robotic devices 390.

In some implementations, each of the robotic devices 390 has a corresponding and assigned charging station such that the number of robotic devices 390 equals the number of charging stations. In these implementations, the robotic devices 390 always navigate to the specific charging station assigned to that robotic device. For instance, a first robotic device may always use a first charging station and a second robotic device may always use a second charging station.

In some examples, the robotic devices 390 may share charging stations. For instance, the robotic devices 390 may use one or more community charging stations that are capable of charging multiple robotic devices 390. The community charging station may be configured to charge multiple robotic devices 390 in parallel. The community charging station may be configured to charge multiple robotic devices 390 in serial such that the multiple robotic devices 390 take turns charging and, when fully charged, return to a predefined home base or reference location in the home that is not associated with a charger. The number of community charging stations may be less than the number of robotic devices 390.

Also, the charging stations may not be assigned to specific robotic devices 390 and may be capable of charging any of the robotic devices 390. In this regard, the robotic devices 390 may use any suitable, unoccupied charging station when not in use. For instance, when one of the robotic devices 390 has completed an operation or is in need of battery charge, the control unit 310 references a stored table of the occupancy status of each charging station and instructs the robotic device to navigate to the nearest charging station that is unoccupied.

The system 300 further includes one or more integrated security devices 380. The one or more integrated security devices may include any type of device used to provide alerts based on received sensor data. For instance, the one or more control units 310 may provide one or more alerts to the one or more integrated security input/output devices 380. Additionally, the one or more control units 310 may receive sensor data from the sensors 320 and determine whether to provide an alert to the one or more integrated security input/output devices 380.

The sensors 320, the home automation controls 322, the camera 330, the thermostat 334, and the integrated security devices 380 may communicate with the controller 312 over communication links 324, 326, 328, 332, 338, and 384. The communication links 324, 326, 328, 332, 338, and 384 may be a wired or wireless data pathway configured to transmit signals from the sensors 320, the home automation controls 322, the camera 330, the thermostat 334, and the integrated security devices 380 to the controller 312. The sensors 320, the home automation controls 322, the camera 330, the thermostat 334, and the integrated security devices 380 may continuously transmit sensed values to the controller 312, periodically transmit sensed values to the controller 312, or transmit sensed values to the controller 312 in response to a change in a sensed value.

The communication links 324, 326, 328, 332, 338, and 384 may include a local network. The sensors 320, the home automation controls 322, the camera 330, the thermostat 334, and the integrated security devices 380, and the controller 312 may exchange data and commands over the local network. The local network may include 802.11 “Wi-Fi” wireless Ethernet (e.g., using low-power Wi-Fi chipsets), Z-Wave, ZigBee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 360 is an electronic device configured to provide monitoring services by exchanging electronic communications with the control unit 310, the one or more user devices 340 and 350, and the central alarm station server 370 over the network 305. For example, the monitoring server 360 may be configured to monitor events (e.g., alarm events) generated by the control unit 310. In this example, the monitoring server 360 may exchange electronic communications with the network module 314 included in the control unit 310 to receive information regarding events (e.g., alerts) detected by the control unit 310. The monitoring server 360 also may receive information regarding events (e.g., alerts) from the one or more user devices 340 and 350.

In some examples, the monitoring server 360 may route alert data received from the network module 314 or the one or more user devices 340 and 350 to the central alarm station server 370. For example, the monitoring server 360 may transmit the alert data to the central alarm station server 370 over the network 305.

The monitoring server 360 may store sensor and image data received from the monitoring system 300 and perform analysis of sensor and image data received from the monitoring system 300. Based on the analysis, the monitoring server 360 may communicate with and control aspects of the control unit 310 or the one or more user devices 340 and 350.

The monitoring server 360 may provide various monitoring services to the system 300. For example, the monitoring server 360 may analyze the sensor, image, and other data to determine an activity pattern of a resident of the home monitored by the system 300. In some implementations, the monitoring server 360 may analyze the data for alarm conditions or may determine and perform actions at the home by issuing commands to one or more of the controls 322, possibly through the control unit 310.

The central alarm station server 370 is an electronic device configured to provide alarm monitoring service by exchanging communications with the control unit 310, the one or more mobile devices 340 and 350, and the monitoring server 360 over the network 305. For example, the central alarm station server 370 may be configured to monitor alerting events generated by the control unit 310. In this example, the central alarm station server 370 may exchange communications with the network module 314 included in the control unit 310 to receive information regarding alerting events detected by the control unit 310. The central alarm station server 370 also may receive information regarding alerting events from the one or more mobile devices 340 and 350 and/or the monitoring server 360.

The central alarm station server 370 is connected to multiple terminals 372 and 374. The terminals 372 and 374 may be used by operators to process alerting events. For example, the central alarm station server 370 may route alerting data to the terminals 372 and 374 to enable an operator to process the alerting data. The terminals 372 and 374 may include general-purpose computers (e.g., desktop personal computers, workstations, or laptop computers) that are configured to receive alerting data from a server in the central alarm station server 370 and render a display of information based on the alerting data. For instance, the controller 312 may control the network module 314 to transmit, to the central alarm station server 370, alerting data indicating that a sensor 320 detected motion from a motion sensor via the sensors 320. The central alarm station server 370 may receive the alerting data and route the alerting data to the terminal 372 for processing by an operator associated with the terminal 372. The terminal 372 may render a display to the operator that includes information associated with the alerting event (e.g., the lock sensor data, the motion sensor data, the contact sensor data, etc.) and the operator may handle the alerting event based on the displayed information.

In some implementations, the terminals 372 and 374 may be mobile devices or devices designed for a specific function. Although FIG. 3 illustrates two terminals for brevity, actual implementations may include more (and, perhaps, many more) terminals.

The one or more authorized user devices 340 and 350 are devices that host and display user interfaces. For instance, the user device 340 is a mobile device that hosts or runs one or more native applications (e.g., the smart home application 342). The user device 340 may be a cellular phone or a non-cellular locally networked device with a display. The user device 340 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 340 may perform functions unrelated to the monitoring system, such as placing personal telephone calls, playing music, playing video, displaying pictures, browsing the Internet, maintaining an electronic calendar, etc.

The user device 340 includes a smart home application 342. The smart home application 342 refers to a software/firmware program running on the corresponding mobile device that enables the user interface and features described throughout. The user device 340 may load or install the smart home application 342 based on data received over a network or data received from local media. The smart home application 342 runs on mobile devices platforms, such as iPhone, iPod touch, Blackberry, Google Android, Windows Mobile, etc. The smart home application 342 enables the user device 340 to receive and process image and sensor data from the monitoring system.

The user device 350 may be a general-purpose computer (e.g., a desktop personal computer, a workstation, or a laptop computer) that is configured to communicate with the monitoring server 360 and/or the control unit 310 over the network 305. The user device 350 may be configured to display a smart home user interface 352 that is generated by the user device 350 or generated by the monitoring server 360. For example, the user device 350 may be configured to display a user interface (e.g., a web page) provided by the monitoring server 360 that enables a user to perceive images captured by the camera 330 and/or reports related to the monitoring system. Although FIG. 3 illustrates two user devices for brevity, actual implementations may include more (and, perhaps, many more) or fewer user devices.

In some implementations, the one or more user devices 340 and 350 communicate with and receive monitoring system data from the control unit 310 using the communication link 338. For instance, the one or more user devices 340 and 350 may communicate with the control unit 310 using various local wireless protocols such as Wi-Fi, Bluetooth, Z-wave, ZigBee, HomePlug (Ethernet over power line), or wired protocols such as Ethernet and USB, to connect the one or more user devices 340 and 350 to local security and automation equipment. The one or more user devices 340 and 350 may connect locally to the monitoring system and its sensors and other devices. The local connection may improve the speed of status and control communications because communicating through the network 305 with a remote server (e.g., the monitoring server 360) may be significantly slower.

Although the one or more user devices 340 and 350 are shown as communicating with the control unit 310, the one or more user devices 340 and 350 may communicate directly with the sensors and other devices controlled by the control unit 310. In some implementations, the one or more user devices 340 and 350 replace the control unit 310 and perform the functions of the control unit 310 for local monitoring and long range/offsite communication.

In other implementations, the one or more user devices 340 and 350 receive monitoring system data captured by the control unit 310 through the network 305. The one or more user devices 340, 350 may receive the data from the control unit 310 through the network 305 or the monitoring server 360 may relay data received from the control unit 310 to the one or more user devices 340 and 350 through the network 305. In this regard, the monitoring server 360 may facilitate communication between the one or more user devices 340 and 350 and the monitoring system.

In some implementations, the one or more user devices 340 and 350 may be configured to switch whether the one or more user devices 340 and 350 communicate with the control unit 310 directly (e.g., through link 338) or through the monitoring server 360 (e.g., through network 305) based on a location of the one or more user devices 340 and 350. For instance, when the one or more user devices 340 and 350 are located close to the control unit 310 and in range to communicate directly with the control unit 310, the one or more user devices 340 and 350 use direct communication. When the one or more user devices 340 and 350 are located far from the control unit 310 and not in range to communicate directly with the control unit 310, the one or more user devices 340 and 350 use communication through the monitoring server 360.

Although the one or more user devices 340 and 350 are shown as being connected to the network 305, in some implementations, the one or more user devices 340 and 350 are not connected to the network 305. In these implementations, the one or more user devices 340 and 350 communicate directly with one or more of the monitoring system components and no network (e.g., Internet) connection or reliance on remote servers is needed.

In some implementations, the one or more user devices 340 and 350 are used in conjunction with only local sensors and/or local devices in a house. In these implementations, the system 300 includes the one or more user devices 340 and 350, the sensors 320, the home automation controls 322, the camera 330, the robotic devices 390, and the intrusion detection system 357. The one or more user devices 340 and 350 receive data directly from the sensors 320, the home automation controls 322, the camera 330, the robotic devices 390, and the intrusion detection system 357 and sends data directly to the sensors 320, the home automation controls 322, the camera 330, the robotic devices 390, and the intrusion detection system 357. The one or more user devices 340, 350 provide the appropriate interfaces/processing to provide visual surveillance and reporting.

In other implementations, the system 300 further includes network 305 and the sensors 320, the home automation controls 322, the camera 330, the thermostat 334, the robotic devices 390, and the intrusion detection system 357 are configured to communicate sensor and image data to the one or more user devices 340 and 350 over network 305 (e.g., the Internet, cellular network, etc.). In yet another implementation, the sensors 320, the home automation controls 322, the camera 330, the thermostat 334, the robotic devices 390, and the intrusion detection system 357 (or a component, such as a bridge/router) are intelligent enough to change the communication pathway from a direct local pathway when the one or more user devices 340 and 350 are in close physical proximity to the sensors 320, the home automation controls 322, the camera 330, the thermostat 334, the robotic devices 390, and the intrusion detection system 357 to a pathway over network 305 when the one or more user devices 340 and 350 are farther from the sensors 320, the home automation controls 322, the camera 330, the thermostat 334, the robotic devices 390, and the intrusion detection system 357. In some examples, the system leverages GPS information from the one or more user devices 340 and 350 to determine whether the one or more user devices 340 and 350 are close enough to the sensors 320, the home automation controls 322, the camera 330, the thermostat 334, the robotic devices 390, and the intrusion detection system 357 to use the direct local pathway or whether the one or more user devices 340 and 350 are far enough from the sensors 320, the home automation controls 322, the camera 330, the thermostat 334, the robotic devices 390, and the intrusion detection system 357 that the pathway over network 305 is required. In other examples, the system leverages status communications (e.g., pinging) between the one or more user devices 340 and 350 and the sensors 320, the home automation controls 322, the camera 330, the thermostat 334, the robotic devices 390, and the intrusion detection system 357 to determine whether communication using the direct local pathway is possible. If communication using the direct local pathway is possible, the one or more user devices 340 and 350 communicate with the sensors 320, the home automation controls 322, the camera 330, the thermostat 334, the robotic devices 390, and the intrusion detection system 357 using the direct local pathway. If communication using the direct local pathway is not possible, the one or more user devices 340 and 350 communicate with the sensors 320, the home automation controls 322, the camera 330, the thermostat 334, the robotic devices 390, and the intrusion detection system 357 using the pathway over network 305.

In some implementations, the system 300 provides end users with access to images captured by the camera 330 to aid in decision-making. The system 300 may transmit the images captured by the camera 330 over a wireless WAN network to the user devices 340 and 350. Because transmission over a wireless WAN network may be relatively expensive, the system 300 can use several techniques to reduce costs while providing access to significant levels of useful visual information (e.g., compressing data, down-sampling data, sending data only over inexpensive LAN connections, or other techniques).

In some implementations, a state of the monitoring system 300 and other events sensed by the monitoring system 300 may be used to enable/disable video/image recording devices (e.g., the camera 330). In these implementations, the camera 330 may be set to capture images on a periodic basis when the alarm system is armed in an “away” state, but set not to capture images when the alarm system is armed in a “home” state or disarmed. In addition, the camera 330 may be triggered to begin capturing images when the alarm system detects an event, such as an alarm event, a door-opening event for a door that leads to an area within a field of view of the camera 330, or motion in the area within the field of view of the camera 330. In other implementations, the camera 330 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A computer-implemented method comprising:
determining, by an intrusion detection system and using data captured by one or more sensors that are physically located at a premises, a predicted intruder physical location of a likely intruder at the premises;
determining, by the intrusion detection system, a predicted non-intruder physical location of a person at the premises who is not the likely intruder;
selecting, by the intrusion detection system and using the predicted intruder physical location and the predicted non-intruder physical location, one or more shared sensors from a plurality of sensors physically located at the premises, the plurality of sensors including the one or more sensors; and
providing, by the intrusion detection system and to another system, data captured by the one or more shared sensors.

2. The method of claim 1, wherein providing the data captured by the one or more shared sensors comprising providing, by the intrusion detection system and to the other system operated by the person at the premises who is not the likely intruder, the data captured by the one or more shared sensors.

3. The method of claim 1, wherein:
the predicted intruder physical location comprises an first area at the premises in which the likely intruder has at least a first threshold likelihood of being located; and
the predicted non-intruder physical location comprises a second area at the premises in which the person at the premises who is not the likely intruder has at least a second threshold likelihood of being located.

4. The method of claim 3, wherein the first area and the second area do not overlap.

5. The method of claim 3, wherein the first area and the second area overlap at least in part.

6. The method of claim 1, wherein selecting the one or more shared sensors comprises selecting the one or more sensors from the plurality of sensors.

7. The method of claim 1, wherein selecting the one or more shared sensors comprises selecting, from the plurality of sensors, at least one sensors other than the one or more sensors as one of the one or more shared sensors.

8. The method of claim 1, wherein selecting the one or more shared sensors comprises selecting, by the intrusion detection system, the one or more shared sensors from the plurality of sensors physically located at the premises using i) the predicted intruder physical location, ii) the predicted non-intruder physical location, and iii) one or more other predicted physical locations each for another person at the premises.

9. The method of claim 1, wherein providing the data captured by the one or more shared sensors comprises providing, to the other system and for each of the one or more shared sensors, i) the data captured by the respective sensor and ii) second data that indicates whether the captured data is for a first area within a threshold distance the predicted intruder physical location or for a second area within a second threshold distance the predicted non-intruder physical location.

10. The method of claim 1, wherein providing the data comprises providing, by the intrusion detection system and to the other system using a temporary connection that expires after a time period, the data.

11. The method of claim 10, comprising determining a duration for the time period using at least one of a predicted intrusion type or the data captured by the one or more sensors that are physically located at the premises.

12. The method of claim 10, comprising:
determining that an emergency event will not likely end by an end of the time period; and
in response to determining that the emergency event will not likely end by the end of the time period, extending a duration for the time period.

13. The method of claim 1, comprising:
receiving, from the other system, a request to control a device physically located at the premises;
determining whether permission data for the device indicates that the other system can control the device; and
in response to determining whether the permission data for the device indicates that the other system can control the device, selectively providing or denying the other system's control of the device.

14. The method of claim 1, wherein determining the predicted non-intruder physical location comprises determining the predicted non-intruder physical location using data captured by a sensor from the plurality of sensors.

15. The method of claim 1, wherein determining the predicted non-intruder physical location comprises determining the predicted non-intruder physical location using location information received from a device operated by the person at the premises who is not the likely intruder.

16. The method of claim 1, comprising:
determining, by the intrusion detection system, that a likelihood that the likely intruder is at the predicted intruder physical location no longer satisfies a threshold likelihood; and
stopping, by the intrusion detection system, the provision to the other system of data captured by a sensor that was selected using the predicted intruder physical location.

17. A system comprising one or more computers and one or more storage devices on which are stored instructions that are operable, when executed by the one or more computers, to cause the one or more computers to perform operations comprising:
determining, using data captured by one or more sensors that are physically located at a premises, a predicted intruder physical location of a likely intruder at the premises;
determining a predicted non-intruder physical location of a person at the premises who is not the likely intruder;
selecting, using the predicted intruder physical location and the predicted non-intruder physical location, one or more shared sensors from a plurality of sensors physically located at the premises, the plurality of sensors including the one or more sensors; and
providing, to another system, data captured by the one or more shared sensors.

18. The system of claim 17, wherein providing the data captured by the one or more shared sensors comprising providing, by the intrusion detection system and to the other system operated by the person at the premises who is not the likely intruder, the data captured by the one or more shared sensors.

19. The system of claim 17, wherein:
the predicted intruder physical location comprises an first area at the premises in which the likely intruder has at least a first threshold likelihood of being located; and
the predicted non-intruder physical location comprises a second area at the premises in which the person at the premises who is not the likely intruder has at least a second threshold likelihood of being located.

20. One or more non-transitory computer storage media encoded with instructions that, when executed by one or more computers, cause the one or more computers to perform operations comprising:
determining, using data captured by one or more sensors that are physically located at a premises, a predicted intruder physical location of a likely intruder at the premises;
determining a predicted non-intruder physical location of a person at the premises who is not the likely intruder;
selecting, using the predicted intruder physical location and the predicted non-intruder physical location, one or more shared sensors from a plurality of sensors physically located at the premises, the plurality of sensors including the one or more sensors; and
providing, to another system, data captured by the one or more shared sensors.
